(19) United States
(12) Patent Application Publication
(10) Pub. No.: US 2008/0011975 A1
(43) Pub. Date: Jan. 17, 2008

(54) WEAR-RESISTANT PLUG HEAD

(75) Inventors: Jeffrey C. Robison, Provo, UT (US); Michael R. Luque, Orem, UT (US); Craig C. Smith, Provo, UT (US); Stephen R. Chipman, Provo, UT (US)

Correspondence Address: SNELL & WILMER L.L.P.;One Arizona Center, 400 East Van Buren, Phoenix, AZ, 85004-2202, US

(73) Assignee: CALDERA ENGINEERING, LC, Provo, UT (US)

(21) Appl. No.: 11/766,715

(22) Filed: Jun. 21, 2007

Related U.S. Application Data
(60) Provisional application No. 60/805,450, filed on Jun. 21, 2006.

(51) Int. Cl. F16K 27/00

(52) U.S. Cl. 251/366

(57) ABSTRACT

As set forth in the detailed description, the present invention includes, in various exemplary embodiments, a valve device to control fluid flow that incorporates a substantially flat plug head. By incorporating a substantially flat plug head, the valve device realizes lower stresses than other typical valve configurations; namely thermal and tensile stress is reduced throughout the valve device. In an exemplary embodiment of this invention, the valve device comprises a housing, at least one plug head seat within the housing, a substantially planar or flat plug head configured to control or stop flow of a substance and a plug stem configured to actuate the substantially flat plug head. In accordance with one exemplary embodiment, the substantially flat plug head comprises a solid disk shaped or cylindrical shaped plug head. Additionally, in one exemplary embodiment, the plug head and plug head seat material can comprise ceramics and various metal alloys.

### RELATED APPLICATIONS

This application claims priority to U.S. Provisional Application Ser. No. 60/805,450, filed Jun. 21, 2006 and entitled “Disc Shaped Plug Head.”

### FIELD OF INVENTION

This invention relates to valve devices for controlling a fluid flow stream. More specifically, this invention relates to a valve device that reduces the impingement angle of a fluid flow stream on the plug head as the fluid passes between a valve plug head and a plug head seat by incorporating a valve plug head that has a substantially flat surface. The substantially flat plug head realizes less assembly and thermally induced stress associated with a pressure drop by hot flow streams and realizes benefits from the reduced stress.

### BACKGROUND OF THE INVENTION

The present invention relates to valve devices for reducing flow impingement angle, assembly stress, thermal stress and thus increasing longevity of severe duty service valves. Various valve devices have been used for some time to control fluid flow through a conduit and/or orifice. Typically, these prior devices are made of non-ceramic materials that tend to wear away quickly in hot, erosive and/or corrosive flow streams or, if having a ceramic plug head and plug head seat, are susceptible to contact failure. Specifically, stress caused by either flow induced thermal gradients, thermal shock or the contact between a ceramic plug head and plug head seat can cause the plug head to chip and/or break. Due to this possibility of contact failure, many of the prior ceramic valve devices are not able to shut off the flow entirely.

Moreover, these prior devices comprise various shapes and configurations to regulate fluid flow. However, many of these shapes and configurations, although satisfactory in their ability to regulate fluid flow, experience stresses by the valve plug heads, and such stresses are often characterized as steep stress gradients within the plug head. In this regard, the present invention generally discloses a valve device for minimizing stress and for minimizing valve failure due to thermal gradients or shock.

### SUMMARY OF THE INVENTION

As set forth in the detailed description, the present invention includes, in various exemplary embodiments, a valve device to control fluid flow that incorporates a substantially flat plug head. By incorporating a substantially flat plug head, the valve device realizes lower stresses than other typical valve configurations; namely thermal and tensile stress is reduced throughout the valve device.

In an exemplary embodiment of this invention, the valve device comprises a housing, at least one plug head seat within the housing, a substantially planar or flat plug head configured to control or stop flow of a substance and a plug stem configured to actuate the substantially flat plug head. In accordance with one exemplary embodiment, the substantially flat plug head comprises a solid disk shaped ceramic plug head.

Additionally, in one exemplary embodiment, the substantially flat plug head comprises a cylindrical shaped ceramic plug head. In yet another exemplary embodiment, the plug head and plug head seat material can comprise ceramics and various metal alloys.

### BRIEF DESCRIPTION OF THE DRAWINGS

A more complete understanding of the present invention, however, may best be obtained by referring to the detailed description when considered in connection with the drawing figures, wherein like numerals denote like elements and wherein:

FIG. 1 illustrates an exemplary prior art parabolic plug head;

FIG. 2 depicts images of thermal gradients and images of tensile stress for both the prior art parabolic plug head-type valve and the substantially flat plug head in accordance with an exemplary embodiment of the present invention;

FIG. 3 illustrates a flat valve assembly in accordance with an exemplary embodiment of the present invention;

FIG. 4 illustrates a flat valve assembly configured with a seal ring and a seal ring seat in accordance with an exemplary embodiment of the present invention;

FIG. 5 illustrates a plug stem with integrated substantially flat plug head in accordance with one exemplary embodiment of the present invention;

FIG. 6A illustrates a substantially flat and solid plug head in accordance with an exemplary embodiment of the present invention; and

FIG. 6B illustrates a substantially flat and cylindrically-shaped plug head in accordance with an exemplary embodiment of the present invention.

### DETAILED DESCRIPTION OF EXEMPLARY EMBODIMENTS

The detailed description of exemplary embodiments of the invention herein, shows various exemplary embodiments and the best modes, known to the inventors at this time. These exemplary embodiments and modes are described in sufficient detail to enable those skilled in the art to practice the invention and are not intended to limit the scope, applicability, or configuration of the invention in any way. Rather, the following disclosure is intended to teach both the implementation of the exemplary embodiments and modes and any equivalent modes or embodiments that are known or obvious to those of reasonable skill in the art. Additionally, all included figures are non-limiting illustrations of the exemplary embodiments and modes, which similarly avail themselves to any equivalent modes or embodiments that are known or obvious to those of reasonable skill in the art.

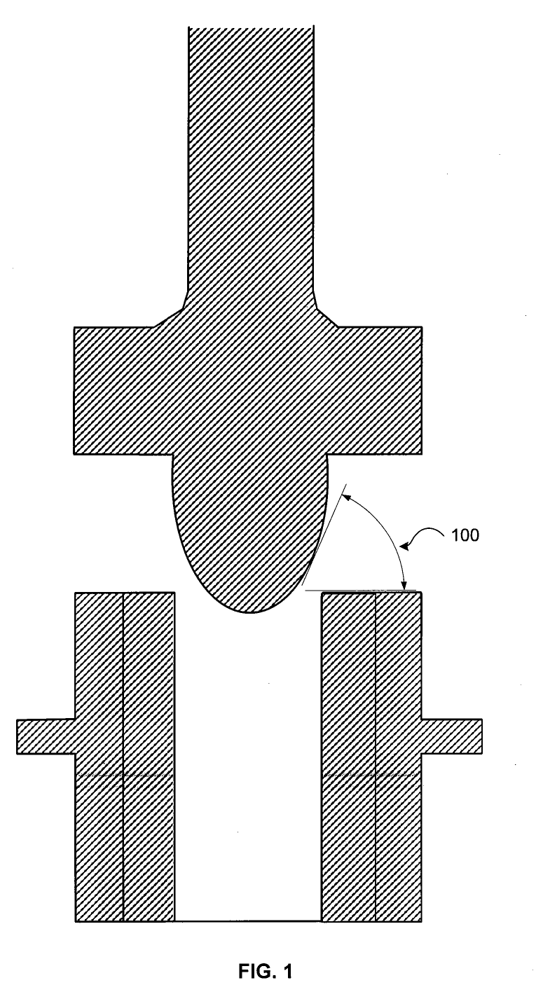

As noted, various valve devices have been used for some time to control fluid flow through a conduit and/or orifice. While prior valves may comprise various shapes and configurations to regulate fluid flow, the most common is the parabolic plug head-type valve. FIG. 1 illustrates an exemplary prior art parabolic plug head. Typically, these parabolic plug head-type valves are superior in their ability to regulate fluid flow. As illustrated in FIG. 1, showing an open parabolic head, as the prior art valve devices close or near the valve seat, the fluid flow is constricted between the plug head and plug seat. This angle is measured between the top surface of the plug head seat and the tangent line drawn from the prior art plug head, commonly referred to as the impingement angle. This angle is shown as numerical reference 100.

However, as the impingement angle decreases the impact between the fluid flow and the prior art plug head is decreased. The prior art plug head protrudes into the flow stream and the impact of hot and caustic flow can cause increased stresses, thermal gradients, and/or thermal shock in the plug head. Ultimately, these impact and thermal stresses can cause the plug head to chip and/or break. Additionally, stresses may be induced by seating the plug head on the plug head seat. These seating stresses are caused by the small plug head surface area in contact with the plug head seat, causing shearing and chipping of the plug head. This shearing can lead to contact failure and can result in inability of the prior art valve devices to shut off the flow entirely. Lastly, many prior art plug heads are made of non-ceramic materials that tend to wear away quickly in hot, erosive and/or corrosive flow streams.

Unlike the prior art plug heads, the plug head of the present invention does not vary the impingement angle or redirect the stream to regulate flow, but instead seals along the top surface of the plug head seat. This seal along the top surface of the plug head seat maximizes the surface area with which the plug head and the plug head seat interface and minimizes the surface area of the plug head available for impact by the fluid flow. Thus, the substantially flat portion of the plug head is advantageous in that it is substantially flat across the plug head seat interface allowing for substantially all of the top surface of the plug head seat to contact the substantially flat portion of the plug head.

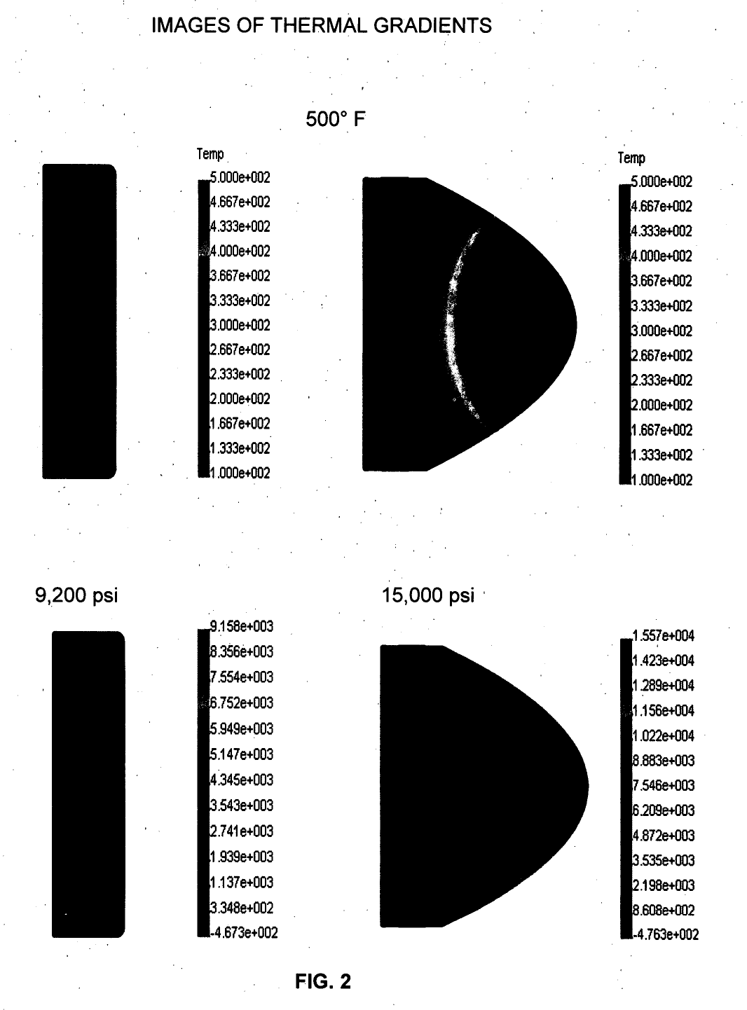

Secondly, the substantially flat portion of the plug head is advantageous in that it does not protrude into the flow and thereby minimizes the surface area of the plug head available for impact by the fluid flow. Thus, in accordance with an exemplary embodiment, the plug head of the present invention is not subjected to the same assembly, impact, and/or thermal stresses as the prior art plug heads. For example, FIG. 2 depicts images of thermal gradients and images of thermally induced tensile stress for both the prior art parabolic plug head-type valve and the plug head in accordance with an exemplary embodiment of the present invention. As illustrated in FIG. 2, the substantially flat or planar geometry of the plug head in accordance with the present invention has been shown, in relation to a parabolic plug head with the same diameter and under the same slurry flow conditions, to reduce the plug head tensile stress. In an exemplary embodiment, the temperature of the slurry flow delivered to the plug head is greater than about 100° C. Further, nn an exemplary embodiment, the pressure of the slurry flow delivered to the plug head is greater than about 50 bar. In an exemplary embodiment, the plug head of the present invention is shown to reduce the plug head tensile stress caused by the press fit assembly by up to about 50%. In another exemplary embodiment, the plug head of the present invention is shown to reduce the plug head assembly tensile stress by up to about 70%. Additionally, in another exemplary embodiment, the plug head of the present invention is shown to reduce the plug head assembly tensile stress by up to about 90%.

Similarly, as illustrated by the thermal gradients in FIG. 2, the planar geometry of the plug head in accordance with the present invention has been shown, in relation to a parabolic plug head with the same diameter and under the same slurry flow conditions, to reduce the plug head thermally induced stress. In an exemplary embodiment, the plug head of the present invention is shown to reduce the plug head thermal stress by up to about 20%. In another exemplary embodiment, the plug head of the present invention is shown to reduce the plug head thermal stress by up to about 40%. Additionally, in another exemplary embodiment, the plug head of the present invention is shown to reduce the plug head thermal stress by up to about 60%.

Valve Assembly

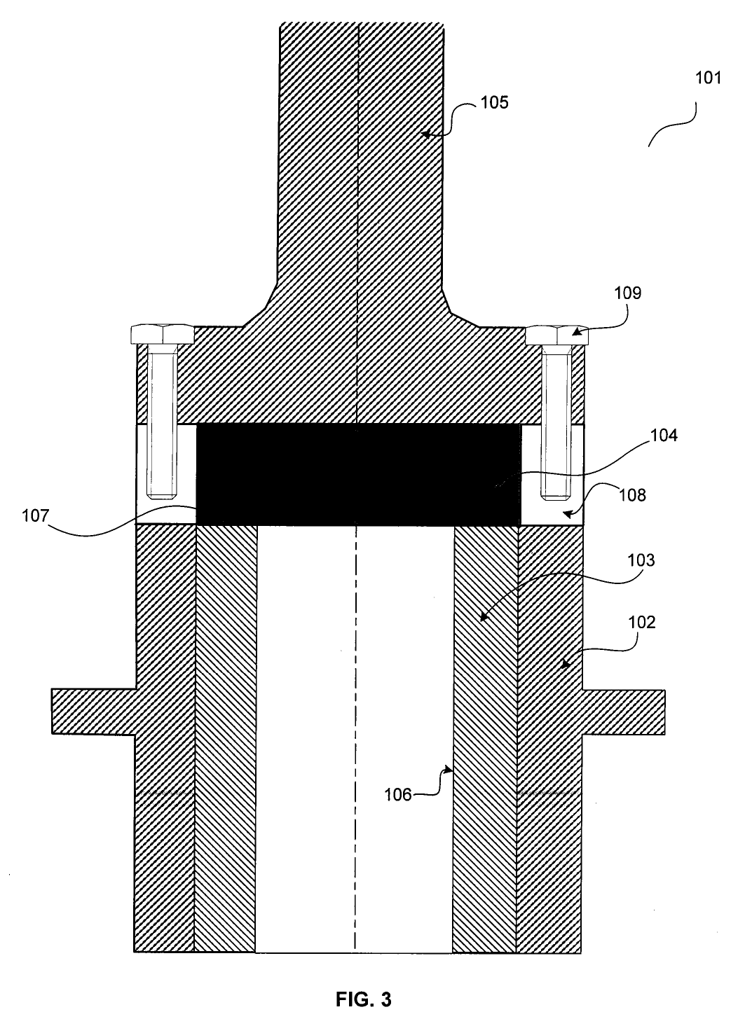

Now turning to the flat valve assembly, discussed with reference to FIG. 3, a valve assembly 101, in accordance with an exemplary embodiment of the present invention, comprises a housing 102, a plug head seat 103, a plug head 104, and a plug stem 105. In accordance with this exemplary embodiment, the plug head seat 103 is configured to be held within the housing 102. In an exemplary embodiment, the plug head seat 103 can comprise a side wall 106 and a top surface 107.

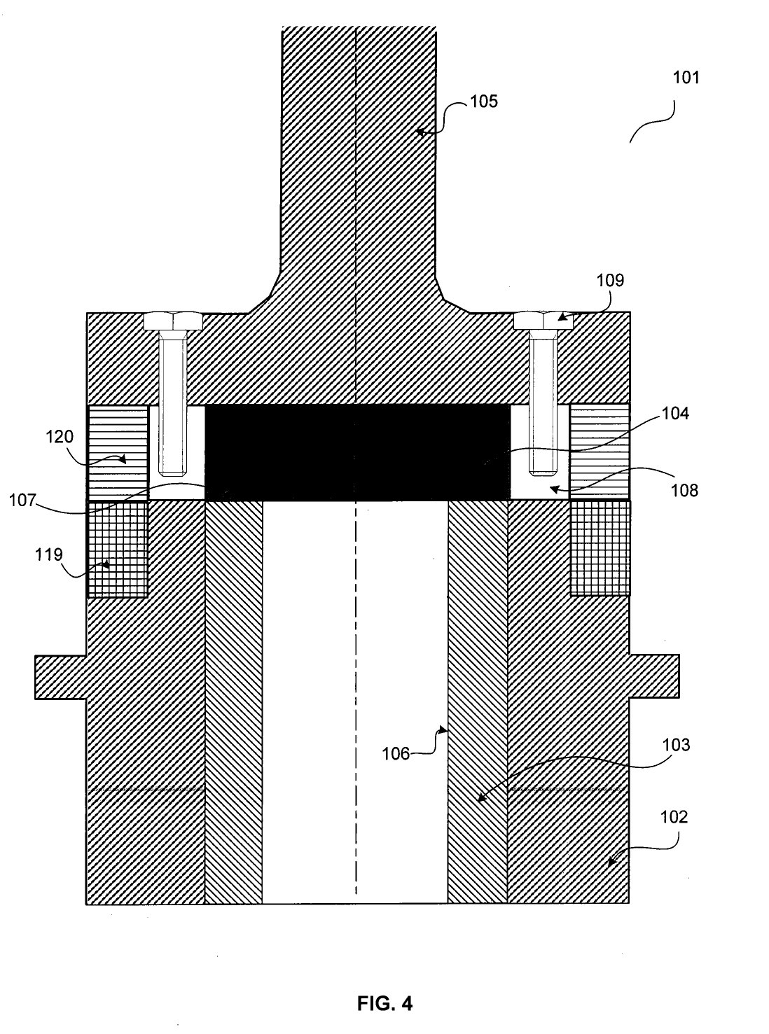

Additionally, discussed with reference to FIG. 4 and in accordance with an exemplary embodiment of the present invention, a flat valve assembly may further comprise a seal ring 120 and a seal ring seat 119. In an exemplary embodiment, the seal ring 120 and the seal ring seat 119 provide a second interface and seal between the valve housing 102 and the plug stem 105.

In an exemplary embodiment, with reference to both FIG. 3 and FIG. 4, the plug head seat 103 can comprise any erosion/corrosion resistance materials and/or any shock absorption materials. In an exemplary embodiment, at least a portion of the plug head seat 103 comprises a structural ceramic because of its resistance to wear and degradation in flow streams that are erosive (having fine-grit particles) and corrosive (due to the chemical composition of the flow). Structural ceramics include, but are not limited to silicon carbide, silicon nitride, aluminum oxide, zirconium oxide, tungsten carbide, whisker-reinforced blends of ceramics, two-phase ceramics and the like. Additionally, in an exemplary embodiment, at least a portion of the plug head seat 103 may comprise a metal. In an exemplary embodiment, said metal comprises at least one of a cast iron, a silicon iron, a white iron, a heat treated martensitic steel (such as 440 or 416 grade steel), and a CrCoFe alloy (such as stellite #3, stellite #6, and stellite #12). Furthermore, in an exemplary embodiment, at least a portion of the plug head seat 103 may comprise a cermet, which is a mixture of any ceramic and any metal.

The plug head seat 103 may be configured to be held within the housing 102 such that it can interface with the plug head 104, as described below, to control the volume of slurry flow passing through the valve. This slurry flow control is metered by the distance between the plug head seat 103 and the plug head 104. This distance is controlled by the actuation of the plug stem 105.

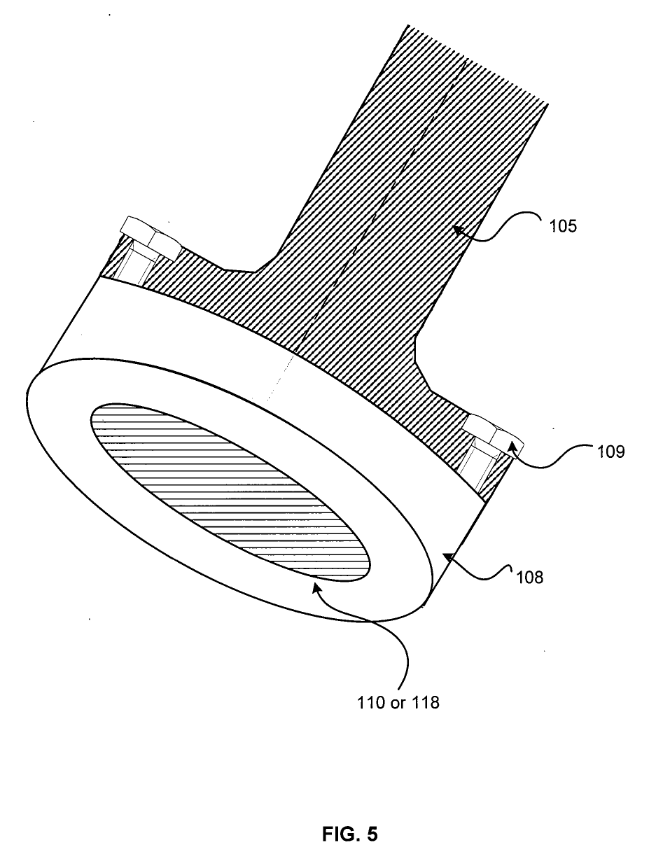

The plug stem 105 and plug head 104 portion of the valve assembly 101 are discussed now with reference to FIG. 5. The plug head 104, as described below, is coupled to the plug stem 105. In an exemplary embodiment, the plug head 104 is coupled to the plug stem 105 with at least one compliant ring 108 and at least one screw 109. Furthermore, any means for coupling the plug head 104 to the plug stem 105 are contemplated within this disclosure. For example, the plug head 104 may be coupled to the plug stem 105 by press fitting, gluing, and/or welding the plug head 104 into the plug stem 105. Additionally, any hardware capable of coupling the plug head 104 to the plug stem 105 is contemplated within this disclosure. In an exemplary embodiment, the plug head 104 may be coupled to the plug stem 105 with at least one of a screw, a rivet, a bolt, and/or a vise.

Furthermore, in accordance with an exemplary embodiment, the plug stem 105 and/or housing 102 may comprise any metal material and/or any ceramic material. In an exemplary embodiment, plug stem 105 and/or housing 102 may comprise including, but not limited to titanium and its alloys, zirconium and its alloys, niobium and its alloys, titanium-niobium alloys, alloy steels, carbon steels, iron-base superalloys, stainless steels, nickel and its alloys, nickel-base superalloys, copper based alloys, cobalt alloys, cobalt-base superalloys, aluminum and its alloys, magnesium alloys, tantalum and the like. Alternative materials with similar properties can be substituted without departing from the concept of this invention.

In this exemplary embodiment, the plug stem 105 is further coupled to an actuating device. This actuating device can be any device configured to move the plug stem 105, thereby changing the distance between the top surface 107 of the plug head seat 103 and the plug head 104.

Plug Head

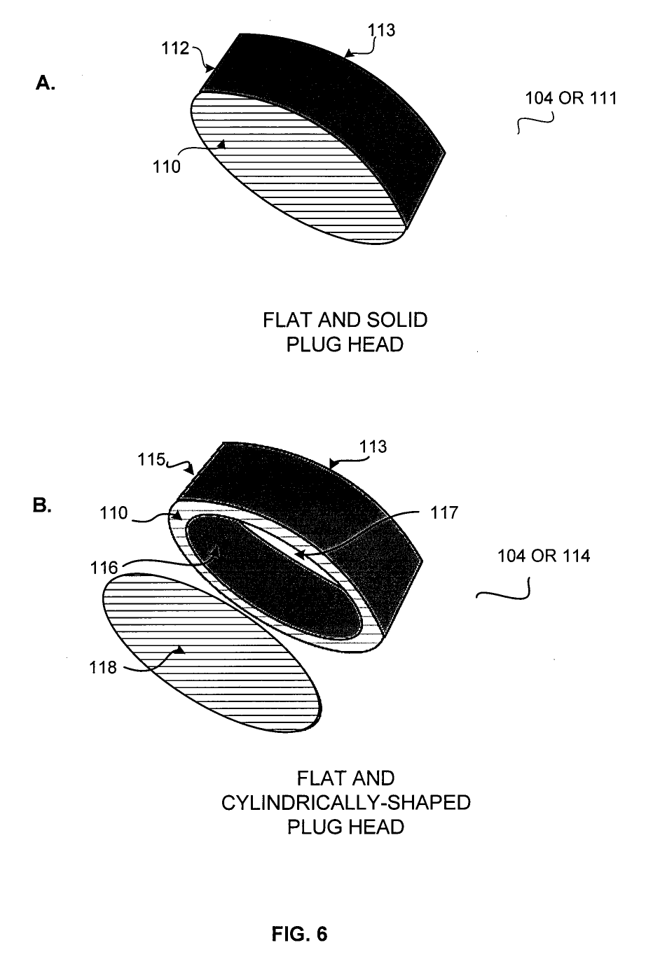

With reference now to FIGS. 6A and 6B and in accordance with an exemplary embodiment of the present invention, at least a portion of the plug head 104 is substantially flat. Moreover, in an exemplary embodiment, the portion of the plug head 104 that is substantially flat, 110, interfaces with plug head seat 103. More specifically, in an exemplary embodiment, the plug head 104 interfaces with the plug head seat 103 by sealing with the top surface 107 of the plug head seat 103, wherein substantially all of the top surface 107 of the plug head seat 103 contacts the substantially flat portion of the plug head 104.

Additionally, in an exemplary embodiment, the entire plug head 104 is substantially flat. In a further exemplary embodiment, in this exemplary embodiment, the plug head 104 does not insert into or enter the opening of the housing 102. In this embodiment, the plug head 104 does not act as a lever arm and thereby minimizes the surface area of the plug head 104 available for impact by fluid flow. Thus, the substantially flat plug head 104 of the present invention is not subjected to the same steep stress and/or thermal forces as the prior art plug heads. It should be understood that the term substantially flat encompasses surfaces that include some curvature and/or variability, but are nonetheless generally planar, low-profile, and/or do not provide a significant lever arm upon, which forces can act.

For example, with reference to FIG. 6A and in accordance with an exemplary embodiment, the substantially flat plug head 104 can be shaped as a solid disk. Furthermore, with reference to FIG. 6B and in accordance with an exemplary embodiment, the substantially flat plug head 104 can shaped as a cylindrically disk.

As illustrated in FIG. 6A and in accordance with an exemplary embodiment, the substantially flat and solid disk plug head 111 comprises a side wall 112, substantially flat surface 110, and a top surface 113, wherein the top surface 113 can comprise a ring surface or solid surface. In an exemplary embodiment, top surface 113 is closed or capped to protect the plug stem 105. In accordance with an exemplary embodiment, the substantially flat surface 110 is configured to interface with the plug head seat 103 and to be in contact with the slurry flow. In accordance with an exemplary embodiment, the substantially flat surface 110 has a circular, an elliptical, a cube, a cuboid, a sphere, an ellipsoid, any of the Platonic solids (tetrahedron, octahedron, dodecahedron), any spheroid (including, but not limited to, prolate and oblate spheroids), a cymbelloid, or an amphoroid shaped cross-section and/or the like.

Additionally, the side wall 112 defines the perimeter or cross-sectional shape of the substantially flat surface 110. In accordance with an exemplary embodiment, the side wall 112 is substantially perpendicular to the substantially flat surface 110. In accordance with an exemplary embodiment, the side wall 112 is at least about 0.05 inch long, thus making the substantially flat plug head 104 or 111 0.05 inch thick. In accordance with another exemplary embodiment, the length of the side wall 112 is between about 0.05 inch to about 12 inch, thus making the substantially flat plug head 104 or 111 between about 0.05 inch to about 12 inch thick. In an exemplary embodiment, the side wall 112 is configured to interface with at least one compliant ring 108 such that the substantially flat plug head 104 or 111 is coupled to the plug stem 105.

Again, as illustrated in FIG. 6A and in accordance with an exemplary embodiment, the substantially flat plug head 104 comprises a top surface 113 configured to interface with the plug stem 105. In an exemplary embodiment, the top surface 113 has the same cross-sectional shape as the substantially flat surface 110.

Furthermore, in an exemplary embodiment, the substantially flat and solid plug head 111 comprises a homogenous material composition throughout the solid plug head. Also, in an exemplary embodiment, the substantially flat and solid plug head 111 comprises a heterogenous material composition throughout the solid plug head. For example, the substantially flat and solid plug head 111 can comprise any erosion/corrosion resistance materials and/or any shock absorption materials. In an exemplary embodiment, at least a portion of substantially flat and solid plug head 111 comprises a structural ceramic because of its resistance to wear and degradation in flow streams that are erosive (having fine-grit particles) and corrosive (due to the chemical composition of the flow). Structural ceramics include, but are not limited to silicon carbide, silicon nitride, aluminum oxide, zirconium oxide, tungsten carbide, whisker-reinforced blends of ceramics, two-phase ceramics and the like. Additionally, in an exemplary embodiment, at least a portion of the substantially flat and solid plug head 111 may comprise a metal. In an exemplary embodiment, said metal comprises at least one of a cast iron, a silicon iron, a white iron, a heat treated martensitic steel (such as 440 or 416 grade steel), and a CrCoFe alloy (such as stellite #3, stellite #6, and stellite #12). Furthermore, in an exemplary embodiment, at least a portion of the substantially flat and solid plug head 111 may comprise a cermet, which is a mixture of any ceramic and any metal.

Additionally, in an exemplary embodiment, the substantially flat and solid plug head 111 has a diameter of about 0.1 inches to about 24 inches, depending on the specific valve application.

Secondly, as illustrated in FIG. 6B and in accordance with an exemplary embodiment, the substantially flat and cylindrical disc plug head 114 comprises an outer wall 115, substantially flat surface 110, an inner wall 116, a top surface 113, and a void space 117.

In accordance with an exemplary embodiment, the substantially flat surface 110 is located between the inner wall 116 and the outer wall 115, is configured to interface with the plug head seat 103, and to be in contact with the slurry flow. In accordance with an exemplary embodiment, the substantially flat surface 110 can define a circular or an elliptical ring shape. Also, in an exemplary embodiment, the substantially flat surface 110 can define a hollow cube, cuboid, ellipsoid, any of the Platonic solids (tetrahedron, octahedron, and dodecahedron), any spheroid (including, but not limited to, prolate and oblate spheroids), a cymbelloid, or an amphoroid shape.

Additionally, in an exemplary embodiment, the outer wall 115 defines the outer perimeter of the substantially flat surface 110 and the inner wall 116 defines the inner perimeter of the substantially flat surface 110. In accordance with an exemplary embodiment, the outer wall 115 and the inner wall 116 are substantially perpendicular to the substantially flat surface 110. Similarly, in accordance with an exemplary embodiment, the outer wall 115 defines the outer perimeter of the top surface 113 and the inner wall 116 defines the inner perimeter of the top surface 113. Stated another way, the inner wall 116 defines the outer perimeter of the void space 117.

In yet another exemplary embodiment, substantially flat surface 110 can be extended to cover void space 117. In this exemplary embodiment, the extended substantially flat surface 118, shown in FIG. 6B as a cut-away, is configured to cap the substantially flat plug head 104 or 114 and, thus is advantageous in minimizing entrained slurry and production costs.

Accordingly, in an exemplary embodiment, the outer wall 115 and the inner wall 116 are the same length and are at least about 0.05 inch long, thus making the substantially flat plug head 104 or 114.05 inch thick. In accordance with another exemplary embodiment, the length of the outer wall 115 and the inner wall 116 is between about 0.05 inch to about 12 inch, thus making the substantially flat plug head 104 or 114 between about 0.05 inch to about 12 inch thick. In an exemplary embodiment, the outer wall 115 is configured to interface with at least one compliant ring 108 such that the substantially flat plug head 104 or 114 is coupled to the plug stem 105.

Again, as illustrated in FIG. 6B and in accordance with an exemplary embodiment, the substantially flat plug head 104 comprises a top surface 113 configured to interface with the plug stem 105. In an exemplary embodiment, the top surface 113 has the same cross-sectional shape as the substantially flat surface 110 or 118.

Furthermore, in an exemplary embodiment, the substantially flat and cylindrical plug head 114, including but not limited to the extended substantially flat surface 118, comprises a homogenous material composition throughout the solid plug head. Also, in an exemplary embodiment, the substantially flat and cylindrical plug head 114, including but not limited to the extended substantially flat surface 118, comprises a heterogenous material composition throughout the solid plug head. For example, the substantially flat and cylindrical plug head 114, including but not limited to the extended substantially flat surface 118, can comprise any erosion/corrosion resistance materials and/or any shock absorption materials. In an exemplary embodiment, at least a portion of substantially flat and cylindrical plug head 114, including but not limited to the extended substantially flat surface 118, comprises a structural ceramic because of its resistance to wear and degradation in flow streams that are erosive (having fine-grit particles) and corrosive (due to the chemical composition of the flow). Structural ceramics include, but are not limited to silicon carbide, silicon nitride, aluminum oxide, zirconium oxide, tungsten carbide, whisker-reinforced blends of ceramics, two-phase ceramics and the like. Additionally, in an exemplary embodiment, at least a portion of the substantially flat and cylindrical plug head 114, including but not limited to the extended substantially flat surface 118, may comprise a metal. In an exemplary embodiment, the metal comprises at least one of a cast iron, a silicon iron, a white iron, a heat treated martensitic steel (such as 440 or 416 grade steel), and a CrCoFe alloy (such as stellite #3, stellite #6, and stellite #12). Furthermore, in an exemplary embodiment, at least a portion of the substantially flat and cylindrical plug head 114, including but not limited to the extended substantially flat surface 118, may comprise a cermet, which is a mixture of any ceramic and any metal.

Additionally, in an exemplary embodiment, the substantially flat and cylindrical plug head 114 has a diameter of about 0.1 inches to about 24 inches, depending on the specific valve application.

Finally, as used herein, the terms “comprise”, “comprises”, “comprising”, “having”, “including”, “includes”, or any variation thereof, are intended to reference a non-exclusive inclusion, such that a process, method, article, composition or apparatus that comprises a list of elements does not include only those elements recited, but can also include other elements not expressly listed and equivalents inherently known or obvious to those of reasonable skill in the art. Other combinations and/or modifications of structures, arrangements, applications, proportions, elements, materials, or components used in the practice of the instant invention, in addition to those not specifically recited, can be varied or otherwise particularly adapted to specific environments, manufacturing specifications, design parameters or other operating requirements without departing from the scope of the instant invention and are intended to be included in this disclosure.

Moreover, unless specifically noted, it is the Applicant's intent that the words and phrases in the specification and the claims be given the commonly accepted generic meaning or an ordinary and accustomed meaning used by those of reasonable skill in the applicable arts. In the instance where these meanings differ, the words and phrases in the specification and the claims should be given the broadest possible, generic meaning. If it is intended to limit or narrow these meanings, specific, descriptive adjectives will be used. Absent the use of these specific adjectives, the words and phrases in the specification and the claims should be given the broadest possible meaning. If any other special meaning is intended for any word or phrase, the specification will clearly state and define the special meaning.

What is claimed is:

1. A valve device comprising:
a housing;
a plug head seat coupled within said housing, wherein said plug head seat comprises a top surface; and
a plug head coupled to a plug stem configured to interface with said top surface of said plug head seat, wherein the surface of said plug head that interfaces with said plug head seat is substantially flat.

2. The valve device of claim 1, wherein the entire plug head surface is substantially flat.

3. The valve device of claim 1, wherein said plug head is a solid disc.

4. The valve device of claim 1, wherein said plug head is a hollow cylinder.

5. The valve device of claim 4, wherein said hollow cylinder comprises a capped-end and wherein said capped-end provides said substantially flat plug head surface.

6. The valve device of claim 1, wherein said plug head has a diameter from about 0.1 inches to about 24 inches.

7. The valve device of claim 1, wherein said plug head comprises at least one of a ceramic material, a metal alloy material, and a cermet material.

8. The valve device of claim 7, wherein said at least one of a ceramic material comprises at least one of carbide, silicon nitride, aluminum oxide, zirconium oxide, tungsten carbide, whisker-reinforced blends of ceramics, and two-phase ceramics.

9. The valve device of claim 7, wherein said at least one of a cermet material comprises a ceramic and at least one of a cast iron, a silicon iron, a white iron, a heat treated martensitic steel, and a CrCoFe alloy.

10. The valve device of claim 1, wherein said plug head seat comprises a ceramic material.

11. The valve device of claim 1, further comprising:
at least one compliant ring coupled to said plug stem configured to maintain the position of said plug head to ensure sealing with said plug head seat.

12. A solid plug head comprising:
a substantially flat surface configured to interface with the top of a plug head seat and to be in contact with a slurry flow;
a side wall, wherein said side wall defines the perimeter of said substantially flat surface; and
a top surface configured to interface with a plug stem, wherein said top surface, said side wall, and said substantially flat surface define a solid.

13. The solid plug head of claim 12 further comprising at least one of a ceramic material, a metal alloy material, and a cermet material.

14. The solid plug head of claim 13, wherein said at least one of a ceramic material comprises at least one of carbide, silicon nitride, aluminum oxide, zirconium oxide, tungsten carbide, whisker-reinforced blends of ceramics, and two-phase ceramics.

15. The solid plug head of claim 13, wherein said at least one of a cermet material comprises a ceramic and at least one of a cast iron, a silicon iron, a white iron, a heat treated martensitic steel, and a CrCoFe alloy.

16. A hollow plug head comprising:
a substantially flat surface configured to interface across the top of a plug head seat and to be in contact with a slurry flow;
a void space
an inner wall, wherein said inner wall defines the inner perimeter of said substantially flat surface and defined the outer perimeter of said void space;
an outer wall, wherein said outer wall defines the outer perimeter of said substantially flat surface; and
a top surface configured to interface with a plug stem, wherein said top surface, said inner wall, said outer wall, and said substantially flat surface define a solid.

17. The hollow plug head of claim 16 further comprising at least one of a ceramic material, a metal alloy material, and a cermet material.

18. The hollow plug head of claim 17, wherein said at least one of a ceramic material comprises at least one of carbide, silicon nitride, aluminum oxide, zirconium oxide, tungsten carbide, whisker-reinforced blends of ceramics, and two-phase ceramics.

19. The hollow plug head of claim 17, wherein said at least one of a cermet material comprises a ceramic and at least one of a cast iron, a silicon iron, a white iron, a heat treated martensitic steel, and a CrCoFe alloy.

20. The hollow plug head of claim 16 further comprising an extended substantially flat surface configured to cap the end of said void space.
